(19) United States
(12) Patent Application Publication
(10) Pub. No.: US 2025/0200197 A1
(43) Pub. Date: Jun. 19, 2025

(54) DATA PROCESSING APPARATUS AND METHOD

(71) Applicant: Sony Group Corporation, Tokyo (JP)

(72) Inventors: Nigel Stuart MOORE, Newbury Berkshire (GB); David Rowland WILLIAMS, Cardiff (GB)

(21) Appl. No.: 18/847,253

(22) PCT Filed: Jan. 17, 2023
(86) PCT No.: PCT/GB2023/050080

§ 371 Date: Sep. 15, 2024

(30) Foreign Application Priority Data
Mar. 31, 2022 (GB) 2204629.6

(51) Int. Cl. G06F 21/60

(52) U.S. Cl. CPC G06F 21/606

(57) ABSTRACT

A data processing apparatus comprising circuitry configured to: determine if the data processing apparatus is in a trusted location; if it is determined that the data processing apparatus is in a trusted location, transmit a beacon signal, the beacon signal comprising a data packet comprising information associated with a user of the data processing apparatus and the data packet having a predetermined property.

### BACKGROUND

### Field of the Disclosure

The present disclosure relates to a data processing apparatus and method.

### Description of the Related Art

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

A beacon signal is a signal (e.g. a radio signal) transmitted by an electronic device to notify another electronic device of its presence. Devices which send beacon signals have become increasingly popular with technology such as Bluetooth® Low Energy (BLE). This, for example, allows BLE beacon devices in public places such as shops, museums and the like to broadcast beacon signals to devices such as smartphones carried by users passing by.

The beacon signal indicates information which might be useful to such users. For example, a beacon device in a coffee shop may broadcast a beacon signal comprising a uniform resource locator (URL), or an encoding of a URL, linking to a webpage showing the menu of the coffee shop. Beacon signals such as BLE beacon signals typically have a relatively short range (an order of magnitude of 10 metres, for example), meaning a user only receives those signals when they are located close to the location of the beacon. Thus, in the given example, a user's smartphone will only receive the beacon signal indicating the URL of the coffee shop menu webpage when they are located in the vicinity of the coffee shop.

Beacon signals such as BLE beacon signals therefore allow users to easily obtain useful information which is specific to their location.

It is desirable to expand the way in which beacon signals can be used. For example, instead of, or in addition to, a user's device receiving beacon signals from a beacon signal transmitting device, it may be desirable for the user's device itself to transmit beacon signals to other devices. Such beacon signals may indicate certain information about the user. This allows, for example, devices of service providers (e.g. beacon signal receivers connected to electronic coffee shop displays, museum displays or the like) to cause information provided to users (e.g. a menu screen or historical information screen) to be tailored to the needs of that specific user. For example, if the beacon signal indicates a user is hard of hearing, then a video display in a museum may automatically provide subtitles to accompany the video when the beacon signal is detected (the detection of the beacon signal indicating the user is nearby). As another example, if the beacon signal indicates a user has a particular allergy, then an electronic menu screen in a coffee shop may only include items which are suitable for people with that allergy when the beacon signal is detected.

Such beacon signals may also be useful in the user's own home. For example, if the user is hard of hearing and shares a house with another person who is not hard of hearing, then a television (TV) in the house may automatically operate in a first mode without subtitles when a beacon signal from the hard of hearing user is not detected and a second mode with subtitles when the beacon signal from the hard of hearing user is detected. Different functionalities of the TV can thus be automatically enabled and disabled for different users.

A problem, however, is that such beacon signals transmitted by user devices such as smartphones and containing information about the user give rise to privacy and security concerns. For example, if a user device regularly broadcasts a beacon signal indicating information about the user as they travel around (e.g. indicating the user is hard of hearing or has an allergy), malicious third parties (or, at least, parties which do not have permission to collect data about the user) may receive the beacon signal (in addition to the parties the beacon signal is intended for), obtain the information about the user and use it for illegal or harmful activities. There is therefore a desire to address this problem.

### SUMMARY

The present disclosure is defined by the claims.

### BRIEF DESCRIPTION OF THE DRAWINGS

Non-limiting embodiments and advantages of the present disclosure are explained with reference to the following detailed description taken in conjunction with the accompanying drawings, wherein:

FIG. 1 schematically shows a data processing apparatus;

FIG. 2 schematically shows a data packet;

FIG. 3 schematically shows a first example use case;

FIG. 4 schematically shows a configuration screen associated with the first example use case;

FIG. 5 schematically shows a scenario to be improved by a second example use case;

FIG. 6 schematically shows a configuration screen associated with the second example use case;

FIG. 7 schematically shows the second example use case;

FIG. 8 shows a first example method; and

FIG. 9 shows a second example method.

Like reference numerals designate identical or corresponding parts throughout the drawings.

### DETAILED DESCRIPTION OF THE EMBODIMENTS

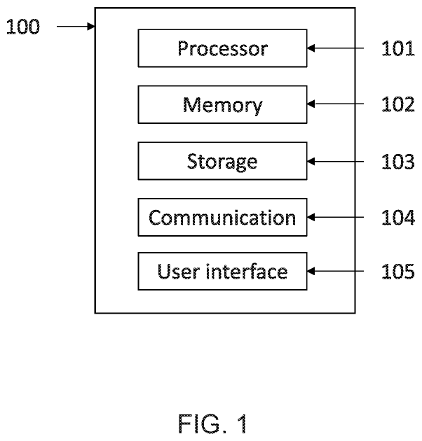

FIG. 1 shows an information processing apparatus/device 100 according to an embodiment. The device 100 is a device such as a smartphone or wearable device (e.g. smartwatch, wristband or the like) carried around by a user, for example. The device 100 a processor 101 for executing electronic instructions, a memory 102 for storing the electronic instructions to be executed and electronic input and output information associated with the electronic instructions, a storage medium 103 (e.g. a hard disk drive or solid state drive) for long term storage of information, a communication interface 104 for sending electronic information to and/or receiving electronic information from one or more other apparatuses and a user interface 105 (e.g. a touch screen, a non-touch screen, buttons, a keyboard, a mouse and/or a voice controlled interface) for receiving commands from and/or outputting information to a user. Each of the processor 101, memory 102, storage medium 103, communication interface 104 and user interface 105 are implemented using appropriate circuitry, for example. The processor 101 controls the operation of each of the memory 102, storage medium 103, communication interface 104 and user interface 105.

In this example, the communication interface 104 is configured to transmit beacon signals comprising information associated with the user. In the examples below, the transmitted beacon signals are BLE beacon signals (e.g. comprising BLE advertising packets). However, the present technique is not limited to this and another type of beacon signal (e.g. Universal Wideband (UWB) signals) with a similarly short transmission range (e.g. an order of magnitude of 10 metres) may be transmitted. The communication interface 104 may comprise a plurality of communication components (not shown) to perform transmission and/or reception of wireless signals using a plurality of different communication protocols. For example, as well as the protocol for transmitting the beacon signals, the communication interface 104 may also be configured to transmit and/or receive wireless local area network (WLAN) signals (such as Wi-Fi® signals) and cellular signals (e.g. 3^{rd} Generation Partnership Project 3G, 4G and/or 5G signals).

In embodiments, a beacon signal (e.g. a BLE beacon signal) is a signal which can be received only within a certain distance from a transmitter of the beacon signal, the certain distance being less than, for example, the operating distance of a typical Wi-Fi network but greater than, for example, the operating distance of near field communication (NFC). The certain distance can be configured, at least in part, by the transmission power of the beacon signal, although it may also be dependent, at least in part, on the sensitivity of the receiver of the beacon signal. Determining location based on receiving a certain beacon signal may therefore be more accurate than, for example, determining location based on receiving a signal from a certain Wi-Fi network. This is especially useful indoors, for example, in which other types of location determination (e.g. using global navigation satellite system, GNSS, coordinates) may not work effectively. In general, a beacon signal is a small amount of data (e.g. an order of magnitude of 10 bytes) that is repeatedly broadcast over a short distance (e.g. an order of magnitude of 10 metres) without being changed between repetitions. It may, however, be reconfigured between sets of repetitions depending on, for example, the requirements of the user.

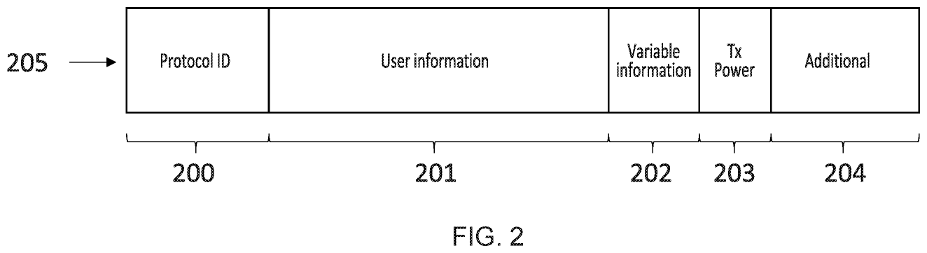

FIG. 2 shows an example data packet 205 comprised in the transmitted beacon signal. An example of such a data packet is a BLE advertising packet. The data packet comprises a plurality of different portions, including a protocol ID portion 200, a user information portion 201, a variable information portion 202, a Tx power portion 203 and an additional portion 204. For ease of explanation, this is a simplified version of the data packet and, in reality, the data packet may comprise further portions and/or sub-portions and/or flags associated with the technical characteristics and requirements of the relevant communication protocol used to transmit the beacon signal.

The protocol ID portion 200 indicates the communication protocol with which the data packet is associated. This allows devices which receive the data packet to determine whether or not they are able to decode the data packet. For example, for BLE advertising packets, the protocol ID may indicate either iBeacon (e.g. for iOS® receiving devices) or Eddystone (e.g. for Android® receiving devices).

The user information portion 201 comprises user information associated with the particular user of the device 100. For instance, to use the above examples, the user information portion 201 may comprise information indicating the user is hard of hearing or has a particular allergy. The user information in the user information portion 201 is therefore potentially sensitive information which the user may wish to share only with trusted parties.

One way in which the user information may be protected is to encrypt the user information in the user information portion 201 such that the user information can only be decrypted by a party having the correct decryption key. The correct decryption key (which may be the same as the encryption key used to encrypt the user information in the case of symmetric encryption or different to the encryption key used to encrypt the user information in the case of asymmetric encryption) is only provided to parties trusted by the user.

However, even if the user information (or even the entire data packet) is encrypted in this way, if the same data packet is repeatedly transmitted by the device 100, the user may still be tracked by unauthorised third parties. This is because even though the user information itself cannot be decrypted by those unauthorised third parties, the same encrypted information is transmitted by the user as they move around over time. The likely movements of specific users can therefore be determined based on the location of various devices which receive the encrypted information.

To further improve the user's privacy and security, the data packet thus includes the variable information portion 202. The variable information portion comprises variable information which changes for the transmission of different instances of the data packet. For example, the variable information may comprise the time of transmission. If the beacon signal comprising the data packet is transmitted periodically at a predetermined time period (e.g. every 1, 2, 5, 10 or 30 seconds), then each beacon signal transmission will have a different time of transmission and thus the variable information in the data packet of each beacon signal transmission will be different.

The encryption is therefore carried out on the user information appended with the variable information. This means that the information to be encrypted (that is, the user information+variable information) is different for each transmission and thus the encrypted version of that information is different for each transmission (even though the same encryption key is used). Repetition of the encrypted information in successively transmitted beacon signals is thus reduced, thereby making it more difficult to track individual users. The receiver of the encrypted information knows the format of the encrypted information (e.g. user information+variable information) and is therefore able to extract the user information after decryption. In an example in which the variable information is the transmission time, the receiver may only accept the encrypted information as genuine if, for example, less than a threshold time period has passed since the transmission time. This helps prevent an unauthorised party from intercepting an encrypted beacon signal transmitted by the device 100 and trying to use it at a later time to impersonate the owner of the device 100, for example.

The Tx power portion 203 indicates the power (Tx power, e.g. measured in Decibel-milliwatts, dBm) with which the beacon signal comprising the data packet 205 was transmitted. This enables a receiving device to calculate an estimated distance of the transmitting device 100 from the receiving device based on the measured power of the received signal. The measured power of the received signal with respect to the Tx power will be lower the greater the distance between the transmitting and receiving devices.

The receiving device determines this distance using a predetermined relationship between the measured power of the received signal, the Tx power of the transmitted signal and the distance. An example of such a predetermined relationship is a suitable log-distance path loss model, for example. The relationship may be different for different transmitting and/or receiving devices (e.g. with different antennae, casing and the like) and can therefore be made more accurate by performing a calibration method, if applicable.

The additional portion 204 comprises any additional information necessary for the proper functioning of the communication protocol used to transmit the data packet, such as a cyclic redundancy check (CRC) code or the like.

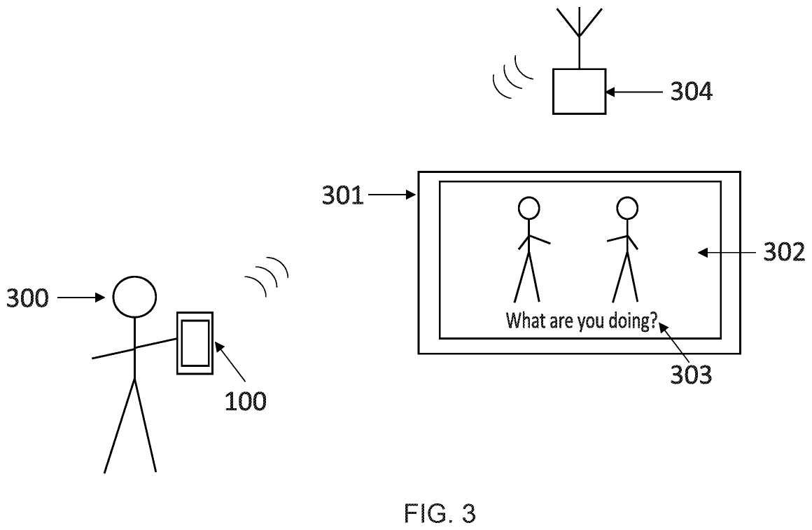

FIG. 3 shows an example of the present technique in which the security of the user's data is further improved. In this example, the user 300 is hard of hearing and has therefore configured the device 100 to transmit a beacon signal indicating they require subtitles when viewing TV shows. Thus, for example, the user information portion 201 of the data packet 205 comprised in the beacon signal comprises the information “Subtitles Required”.

To increase security, the user information may be encrypted, as previously discussed. However, even if variable information is used in the encryption, the encrypted user data may still be associated with one or more trackable characteristics. For example, a repeating pattern of data transmission associated with the device 100 of a particular user (e.g. repetition of a certain data quantity, periodic transmissions separated by a particular time interval or repetition of transmissions with a certain transmission power) may be used to track that user, even though the encrypted user data itself cannot be read and is unpredictable.

Thus, to further increase the security of the user data, rather than the device 100 transmitting the beacon signal comprising the user information “Subtitles Required” all the time, the device 100 only starts transmitting the beacon signal when it is in the vicinity of the user's home. The TV 301 is located in the user's home and then detects the newly transmitted beacon (though a suitable communication interface (not shown) of the TV 301). Subtitles 303 are then provided with images 302 shown on the TV 301 automatically (that is, without the user having to manually turn the subtitles on).

In this example, the device 100 knows it is in the vicinity of the user's home because it detects a service set identifier (SSID) broadcast by the WLAN router 304 (e.g. Wi-Fi router) of the user's home. The broadcast SSID has previously been stored in the device 100 (e.g. in storage medium 103) as the user's home SSID. Thus, when the device 100 detects the user's home SSID in a received broadcast SSID signal, it determines that the user is in the vicinity of their home. This is possible because the SSID can only be determined from a broadcast SSID signal when within range of the broadcast SSD signal (which is typically an order of magnitude of 10 metres, for example). In response to successfully determining the broadcast SSID as the user's home SSID, the device 100 starts transmitting the beacon signal. The beacon signal, in turn, is detected by the TV 301, causing the TV to being display of the subtitles 303.

In the example of FIG. 3, the detection of the user's home SSID in a broadcast SSID signal thus indicates to the device 100 that it is in a location which is trusted by the user (that is, their own home). Other ways of determining whether the device 100 is in such a trusted location may be used.

For example, for added security, the device 100 may only determine it is in a trusted location when it is connected to the WLAN network associated with the broadcast SSID (rather than when it only detects the broadcast SSID). This reduces the risk of the device 100 beginning to transmit the beacon signal in response to a spoof SSID broadcast (in which a copy of the user's home SSID is broadcast by an unauthorised third party). The device 100 is connected to the WLAN network not when it merely receives the broadcast SSID from that network but when, for example, it provides the relevant security credentials to the network (e.g. the correct Wi-Fi Protected Access II (WPA2) key) to enable it to send and receive data over that network. The device 100 will not be able to connect with another WLAN which broadcasts a spoofed version of the SSID using the security credentials of the user's genuine home WLAN since the party spoofing the SSID will not know these credentials. Thus, by the device 100 first establishing a successful connection to a detected WLAN with the relevant SSID using the security credentials associated with that SSID before allowing transmission of the beacon signal to be transmitted, security is further improved.

Alternatively, or in addition, the device may only determine it is in a trusted location when the broadcast SSID signal (or another signal transmitted by the WLAN router 304) is received with at least a threshold signal strength or signal power (thereby indicating the device 100 is within an approximate threshold distance of the WLAN router 304).

The detection of a broadcast SSID is an example and, more generally, the device 100 may transmit the beacon signal in response to detection of any suitable transmitted (e.g. broadcast) signal indicating the presence of a localised wireless network (e.g. WLAN, in particular, a Wi-Fi network) trusted by the device. The localised wireless network has a relatively short (e.g. an order of magnitude of 10 metres, for example) operation distance meaning detection of the presence of the network indicates proximity to a specific location associated with the network. For example, the localised wireless network may be the user's home WLAN (indicating the user is close to their home) or the WLAN associated with a trusted service provider of the user (indicating the user is close to the premises of that service provider). The signal may include, for example, data (e.g. one or more parameters) from which the network may be identified (e.g. a network identifier such as an SSID) and may, for example, comprise payload data or be at the signalling layer.

Alternatively, or in addition, the user may have another, fixed, beacon device (not shown) in their home such as a BLE beacon device. This fixed beacon device continuously transmits beacon signals comprising a unique identifier (e.g. a universally unique identifier, UUID) associated with the user's home. When the device 100 detects beacon signals comprising this unique identifier (the unique identifier previously being stored in the storage medium 103 of the device 100, for example), it begins transmission of its own beacon signal for detection by the TV 301.

Alternatively, or in addition, the device 100 may comprise global navigation satellite system (GNSS) circuitry (not shown) for determining the device's current GNSS location. The device 100 also stores (e.g. in storage medium 103) the GNSS location of the user's home. When it is determined the device's current GNSS location is within a predetermined distance (e.g. 10 metres) of the user's home GNSS location, the device begins transmission of the beacon signal. Geocode systems other than the traditional GNSS geocode system, such as What3Words®, may be used. In this case, for example, transmission of the beacon signal begins when the device 100 is located at the same (or in an adjacent) geocode location as that of the user's home (e.g. in the same or an adjacent 3×3 metre square on earth as that of the user's home in the case of What3Words). The device may still determine its location in this other geocode system based on, for example, its determined GNSS location.

Alternatively, or in addition, the device 100 may determine it is in a trusted location when it is served by a particular cell of a cellular network. For example, the user may indicate to the device 100 when it is connected to the cellular network in the user's home that the user device 100 is in a trusted location. A cell ID (e.g. cell global identity, CGI) of the serving cell is then stored (e.g. in storage medium 103). When a signal comprising that cell ID is detected, it is determined the device 100 is in a trusted location. The device 100, when in the trusted location, begins transmission of the beacon signal.

These are only examples and any other way of allowing the device 100 to determine whether or not it is located at a trusted location (and thus whether or not it should transmit the beacon signal) may be used. In the above examples, the trusted location is the user's home. However, other trusted locations (such as premises of service providers the user signs up) are also envisaged, as exemplified below.

Combinations of such location methods may also be used. For example, to provide a two-factor level of security, a user's home may include a fixed beacon device continuously transmitting a beacon signal comprising a unique identifier associated with the user's home and the device 100 may only transmit its own beacon signal (e.g. the beacon signal comprising the user information “Subtitles Required”) when it both detects the beacon signal of the fixed beacon device and detects the SSID of the user's home WLAN router 304. This provides further security against, for example, SSID spoofing or spoofing of the beacon signal of the fixed beacon device, since detection of only one of the SSID or beacon signal of the fixed device alone will not be sufficient to cause transmission of the beacon signal containing user information by the device 100.

In an example in which such a two-factor level of security is used, it may be that detection of any SSID of a certain type (e.g. any SSID known to be associated with the user's home WLAN provider, such as their internet service provider (ISP)) may be sufficient to allow transmission of the beacon signal of the device 100 when the fulfilment of the other security factor (e.g. presence of the unique identifier associated with the user's home in another detected beacon signal) is confirmed. This may make setup easier for the user, for example, since they do not need to inform the device 100 of their specific SSID but, rather, only need to inform the device 100 of their WLAN provider.

Furthermore, for users who, for example, do not have a WLAN in their home, the device 100 may store an identifier of the WLAN provider associated with a broadcast SSID (e.g. that of a neighbour) detected during a setup process of a different location determining method (e.g. setting up a fixed beacon device and storing the unique identifier comprised in the beacon signal transmitted by the fixed beacon device in the device 100). The device 100 then only transmits the beacon signal comprising the user information when both (a) the location of the device 100 is determined to be a trusted location of the user based on the different location determining method and (b) an SSID of the WLAN provider identified during setup is detected.

This helps provide a second factor of security for the user even if there is no WLAN router in their home. For example, if a third party tries to spoof the unique identifier of the user's fixed beacon device in a different location, this will only work if there also happens to be an SSID of the previously identified WLAN provider which is detectable at the same time. This is difficult for an unauthorised third party to guarantee and thus adds an additional layer of difficulty to such spoofing. This technique may also work based on one or more detected SSIDs themselves (rather than the WLAN provider associated with those SSIDs).

A combination of multiple broadcast SSIDs may be used for further enhanced security. For example, if a user lives in a densely populated area with multiple WLANs, each belonging to a different household and having a respective SSID, one of the condition(s) for transmission of the beacon signal by the device 100 may be detection of that specific combination of SSIDs (or a combination comprising at least a predetermined number of those SSIDs). Alternatively, or in addition, one of the condition(s) for transmission of the beacon signal by the device 100 may be detection of one or more specific SSIDs in combination with detection of a specific cell ID (e.g. CGI), e.g. that of a cell of a cellular network serving the user's home and/or surrounding neighbourhood.

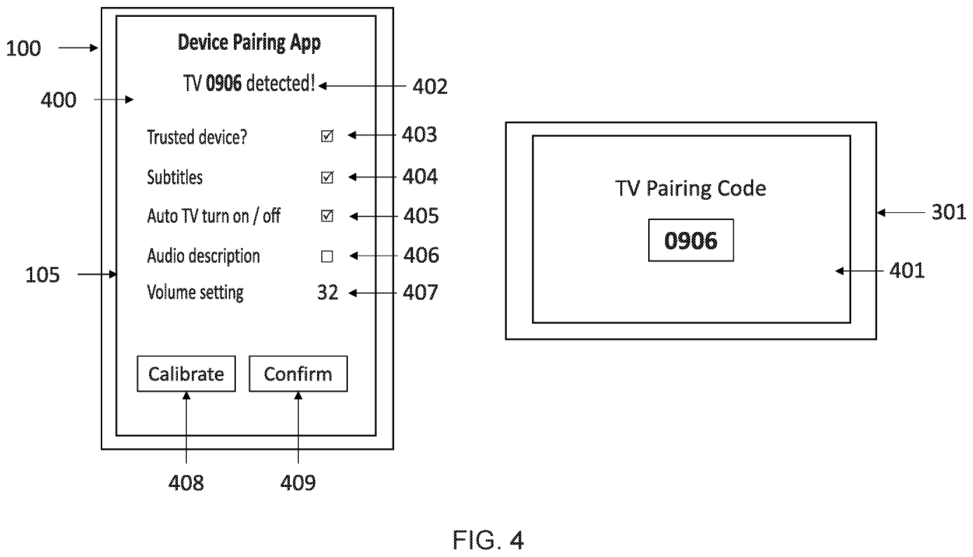

FIG. 4 shows an example of setting up the TV 301 to automatically display subtitles 303 when the device 100 is in the vicinity of the TV based on the above-described examples. In this example, the TV 301 is in the user's home and the device 100 knows it is in the vicinity of the user's home (a trusted location) when it is connected to the user's home WLAN. For example, the device 100 may store the security credentials of the user's home Wi-Fi network so the device 100 automatically connects to this network when the user is in the vicinity of their home. When the device 100 determines it is connected to the user's WLAN, it begins beacon signal transmission. When the device 100 determines it is no longer connected to the user's WLAN (e.g. when the leaves their home and thus moves out of range of the WLAN router 304), it stops beacon signal transmission.

In order to set up what the TV 301 does in response to detecting the beacon signal transmission, the user downloads a suitable software application (app) onto the device 100. The TV app is provided by the TV manufacturer, for example. Once downloaded, the user opens the app. The user also causes the TV (e.g. using a remote control (not shown) and interactive menu system (not shown) of the TV) to enter a pairing mode.

In the pairing mode, the TV displays a pairing mode screen 401 comprising a TV pairing code. The TV pairing code is, for example, a pseudo randomly generated number. The TV also outputs a signal (e.g. a Bluetooth signal) comprising the TV pairing code which is detectable by the device 100 (this detection functionality being enabled by the app, for example). In this case, the TV pairing code is the number ‘0906’. A configuration screen 400 of the app displays a message 402 indicating the TV has been detected and the TV pairing code ‘0906’. This enables the user to check the same TV pairing code is displayed on both the device 100 and the TV 301, thereby ensuring the correct TV is being paired with the device 100 (rather than, for example, a neighbour's TV if that neighbour also happens to be pairing their TV with their smartphone at the same time).

The configuration screen 400 includes a plurality of selectable options (preferences). In this example, the user interface 105 of the device comprises a touch screen. However, the user interface 105 may also comprise, for example, a voice controlled interface, thereby allowing the TV app to be controlled by voice commands uttered by the user.

Some of the selectable options (in this case, the “Trusted device?” option 403, the “Subtitles” option 404, the “Auto TV turn on/off” option 405 and the “Audio description” option 406) are selectable by the user performing a touch operation on the option they wish to select or deselect (with each option toggling between being selected and deselected for successive touch operations). A checkbox next to each option indicates whether or not that option has been selected.

Other selectable options are associated with a selectable value. For example, in this instance, the “Volume setting” option 407 has a selectable value (currently selected as the value ‘32’, with a higher value denoting a higher volume and a lower value denoting a lower volume). The selectable value may be selected by, for example, the user performing a touch operation on the option (e.g. touching the “Volume setting” option 407) which, in response, causes an on-screen numerical keypad to be presented to the user. This allows the user to enter the value associated with the option directly. Alternatively, or in addition, increase and decrease virtual buttons (not shown) may be provided with the option (e.g. one on each side of the value ‘32’) to allow the user to increase or decrease the value in predetermined increments by touching the relevant increase or decrease virtual button.

In this example, the user has selected the “Trusted device?” option 403 to confirm they wish to allow the TV 301 with TV pairing code ‘0906’ to decrypt the beacon signal transmitted by the device 100. This results in, for example, the decryption key necessary for decrypting the user information in the data packet 205 of the beacon signal being transmitted from the device 100 to the TV 301. In an example, when the “Trusted device?” option 403 is selected, a secure communication session (e.g. Bluetooth pairing) is established between the device 100 and TV 301 to enable secure transmission of the decryption key.

In an example, the other selectable options (in this case, the “Subtitles” option 404, the “Auto TV turn on/off” option 405, the “Audio description” option 406 and the “Volume setting” option 407) only become selectable when the “Trusted device?” option 403 is selected. Otherwise, they may appear on the configuration screen (e.g. in a greyed out style) but not be selectable by the user.

In this example, the user has selected the “Subtitles” option 404 and “Auto TV turn on/off” option 405. Selection of the “Subtitles” option 404 causes the TV 301 to automatically display subtitles when the beacon signal from the device 100 is detected. Selection of the “Auto TV turn on/off” option 405 causes the TV 301 to automatically turn on when the beacon signal is detected and turn off when the beacon signal is no longer detected (as occurs, for example, if the user leaves the home). The “Audio description” option 407 is not selected in this instance. However, when it is selected, it causes the TV 301 to automatically add audio description to content when the beacon signal is detected.

The user is thus able to customise the way in which content is provided to them by the TV 301 depending on their individual needs. For example, a user who is hard of hearing may select the “Subtitles” option 404 so that subtitles are automatically displayed when the user is in the vicinity of the TV. They may not, however, select the “Audio description” option 406, since audio description may not be useful to them. In another example, however, a user who is partially sighted may select the “Audio description” option 406 so that audio description is automatically provided when the user is in the vicinity of the TV. They may not, however, select the “Subtitles” option 404, since subtitles may be useful to them.

In an example, the user's selected options (other than the “Trusted device?” option 403, which is required for decryption of the user information of the data packet 205 in the first place) are indicated by the user information of the data packet 205. For example, the user information may comprise a predetermined set of bits (e.g. located at the same location in every transmitted data packet) with values which change depending on the options selected. For instance, the selection or deselection of each of the options 404, 405 and 406 may be indicated by a single respective bit (e.g. ‘1’ for selected, ‘0’ for deselected) at a predetermined location. The “Volume setting” option 407, on the other hand, may be indicated by 8 bits at a predetermined location. The location of the predetermined bits may be known to the TV 301 in advance and indicated to the device 100 by the app, for example.

Once the user has made their selections, they confirm their selections by touching the “Confirm” virtual button 409. This means that, when the user is in the vicinity of their home (as determined, in this particular example, by a successful connection to the user's WLAN being established, as discussed), the device will periodically transmit beacon signals indicating the user's selected options. Thus, when the user watches the TV 301, for example, subtitles will automatically be displayed without the user having to manually enable this. This helps improve user convenience and accessibility. However, once the user leaves the vicinity of their home (as determined, in this particular example, by the connection to the user's WLAN being ending, as discussed), the device will no longer periodically transmit the beacon signals indicating the user's selected options. Protection of the user's privacy is therefore improved.

In an example, different functions of the TV 301 may occur in response to the received power of the beacon signal transmitted by the device 100 being greater than or less than different respective predetermined thresholds (as measured at the TV). For example, if the user has selected both the “Subtitles” option 404 and the “Auto TV turn on/off” option 405, then there may be a first, “TV on”, received beacon signal power threshold which, when exceeded, causes the TV to turn on. There may also be a second, “Subtitles on”, received beacon signal power threshold which, when exceeded, causes the TV to display subtitles. The second threshold may be greater than the first threshold meaning that, for example, as the user first approaches the TV (e.g. by first entering their home), the TV first turns on without subtitles. Then, as the user continues to approach the TV (e.g. by entering the room the TV is in), the TV turns on the subtitles. This helps provide greater flexibility to the user regarding how and when different automatic functions of the TV are activated and deactivated.

In an example, the user may then move away from the TV such that the received power of the beacon signal is again between the first and second thresholds. In this case, the TV remains on (since the received power is still above the first threshold) but turns off the subtitles (since the received power is now below the second threshold). This means, for example, that the TV will display subtitles when the owner of the device 100 is say, in the room the TV is in (and thus may find subtitles useful) but will not display subtitles when the owner leaves the room (thus removing the subtitles for other viewers of the TV in the room who don't need the subtitles, for example). Flexibility with how the TV functionality is used based on the beacon signal of the device 100 is therefore further improved.

In an example, a function of the TV may be associated with multiple received beacon signal power thresholds. For example, the function may be activated (e.g. subtitles turned on) when a first, higher threshold is exceeded but not deactivated (e.g. subtitles turned off) until the measured beacon signal power then falls below a second, lower threshold. This helps alleviate a situation in which, for example, a single threshold is used and the user is positioned approximately stationary at a distance from the TV approximately corresponding to the single threshold. Small changes in, for example, the user's position (e.g. if they are standing still but swinging forwards and backwards) or the Tx power of the beacon signal (e.g. due to radio interference) may then cause the measured power to alternate between being above and below the single threshold, thereby causing the relevant TV function to be alternately activated and deactivated over a short period of time when this is not intended by the user. For example, if the function is the display of subtitles, this will cause the subtitles to be intermittently displayed. This may be considered a hysteresis effect and may be irritating to the user. By using multiple thresholds in the way described, however, this problem is alleviated.

To improve the accuracy with which thresholds are used, in an example, the user is able to calibrate the measurement of the received beacon signal power by touching the “Calibrate” virtual button 408. This causes calibration instructions (not shown) to be displayed to the user. This is useful because, although the Tx power indicted in the beacon signal indicates the expected power with which the beacon signal is transmitted, this may vary for different transmitting devices (e.g. different models and manufacturers) and different environments (e.g. depending on whether there is a clear line of sight between the location of the user or whether there are obstacles in the way).

The calibration instructions, for example, instruct the user to hold the device 100 and stand a predetermined distance (e.g. 1 metre) from the TV 301. The user may approximate this distance themselves (or manually measure the distance) or, for example, if the TV 301 (or a peripheral connected to the TV) comprises a component (e.g. time of flight sensor) which is able to measure the distance between the TV and the user, a measurement from this component may be used. When the user is at the predetermined distance, they inform the device 100 (e.g. by selecting another “Confirm” virtual button (not shown) provided on the screen 105 with the calibration instructions). A signal indicating the user is at the predetermined distance is then transmitted to the TV (e.g. via the same communication session (e.g. Bluetooth pairing) over which the decryption key is transmitted to the TV). At the same time as this transmission (or within a predetermined time period after it, while the user is still located with the device 100 at the predetermined distance from the TV), a sample beacon signal is transmitted to the TV.

The TV is thus able to measure the received beacon signal and is informed of the distance at which it was transmitted. The TV may then adjust the thresholds associated with measuring the received beacon signal power accordingly.

For example, based on the Tx power indicated in the data packet of the sample beacon signal and the device 100 being 1 metre away from the TV when the sample beacon signal was transmitted (1 metre being the predetermined distance, in this case), the TV may expect a received power of X dBm (based on a predefined a suitable log-distance path loss model, for example). If, however, the TV measures a received power of only 0.9*X, then it is determined that the amount of power lost is 10% greater than expected. To compensate for this, any received beacon signal power thresholds may be reduced by 10% so that the distance between the TV 301 and device 100 with which the threshold is associated stays as the user expects.

In another example, the TV may report the measured received power of the sample beacon signal back to the device 100 (again, via the same communication session (e.g. Bluetooth pairing) over which the decryption key is transmitted to the TV, for example). The device 100 then adjusts the power supplied to the antenna which transmits the beacon signal accordingly. Thus, for example, if the amount of power lost as measured by the TV is 10% greater than expected, the device 100 may supply 10% more power to the beacon signal transmission antenna.

This helps ensure the received beacon signal power thresholds perform as expected by the user. In an example, the user may set the received beacon signal power thresholds in units of the distance between the device 100 and TV 301. This may be provided as further configurable options with the calibration information displayed in response to the user selecting the “Calibrate” virtual button 408, for example. By performing the calibration process (and adjusting the thresholds as measured in units of received beacon signal power at the TV and/or the power supplied to the beacon signal transmission antenna at the device 100 accordingly), the likelihood of the thresholds defined in units of distance by the user performing as expected are improved, even with different types of device 100 and in different types of environment.

In another example, instead of or in addition to the options or preferences (e.g. options or preferences 403 to 407) being directly selectable by the user, the configuration screen 400 may allow the user to input information about, for example, a disability they have. Accessibility options will then be selected automatically based on this information. Thus, for example, the user may indicate (e.g. from a drop down menu or the like) that they are hard of hearing. In response, the “Subtitle” option 404 is automatically selected and the “Volume setting” option 407 is automatically set at a higher level. Alternatively, the user may indicate they are partially sighted. In response, the “Audio description” option 406 is automatically selected. This helps a user to set up appropriate accessibility options.

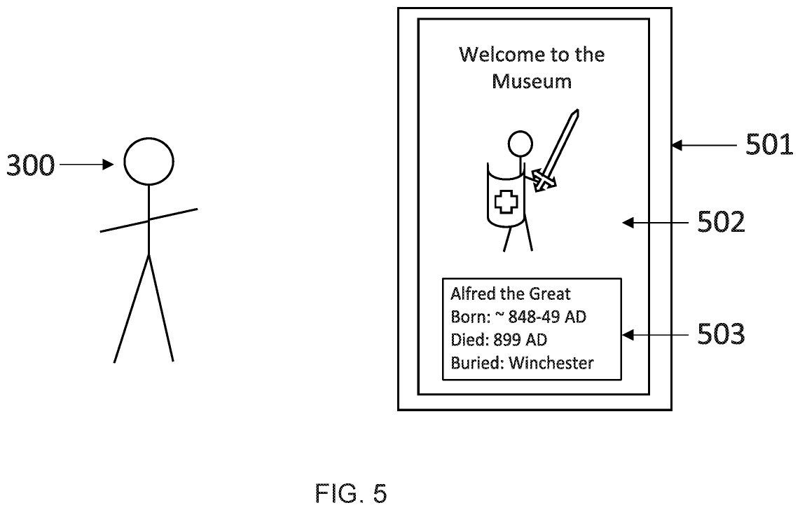

FIG. 5 shows another example implementation of the present technique. In this example, the user 300 is in a public place, namely a museum. The museum has a public electronic display 501 displaying an information screen 502 about the exhibition. The information screen 502 in FIG. 5 is a conventional information screen showing information 503 which is the same for all users.

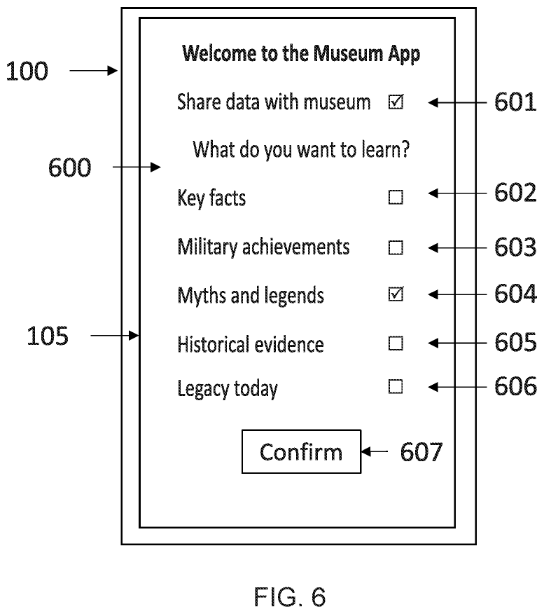

In order to make the museum experience more personalised, prior to visiting the museum, the user downloads a museum app on their device 100. A preference selection screen 600 of the museum app displayed on the device 100 is shown in FIG. 6. Again, in this example, the user interface 105 of the device 100 comprises a touch screen and the preference selection screen 600 is displayed on the touch screen. However, the user interface 105 may also comprise, for example, a voice controlled interface, thereby allowing the museum app to be controlled by voice commands uttered by the user.

The preference selection screen 600 includes a number of selectable options (preferences). The first selectable option 601 allows the user to allow or not allow data from the device 100 to be shared with the museum. Selection or non-selection is, again, indicated by a checkbox. In this case, the user has selected to allow data to be shared with the museum. This allows the other options (all of which require data to be shared with the museum) to be selectable. That is, for example, the other options 602 to 606 only become selectable if the “Share data with museum” option is selected. Otherwise, the options 602 to 606 are not selectable (and, for example, appear in a greyed out style). This helps ensure the user maintains control over which parties have access to user data generated by the device 100.

The options 602 to 606 relate to information the user is interested in and thus the information the user would like to see on the public electronic display 501 when they walk past it at the museum.

Selection of the “Key facts” option 602 causes key facts to be displayed. These are basic facts about the aspect of the exhibition. The information 503 of FIG. 5 is an example of such basic facts. In this case, the exhibition is on the historical figure “King Alfred” and thus the basic facts are about King Alfred.

Selection of the “Military achievements” option 603 means that, instead of the basic facts like those of information 503 being displayed, information on the military achievements of King Alfred is displayed.

Selection of the “Myths and legends” option 604 means that, instead of the basic facts like those of information 503 being displayed, information on myths and legends of King Alfred is displayed.

Selection of the “Historical evidence” option 605 means that, instead of the basic facts like those of information 503 being displayed, information on historical evidence of King Alfred and his achievements is displayed.

Selection of the “Legacy today” option 606 means that, instead of the basic facts like those of information 503 being displayed, information on King Alfred's legacy and his influence on the modern world is displayed.

Rather than the same information 503 being displayed to all users, the preference selection screen 600 of the museum app thus allows individual users to indicate the information about the museum exhibition they are most interested in. This is then the information which is presented to them on the public electronic display 501 when they pass it.

In this example, the user has selected the “Myths and legends” option 604. Thus, after confirming this selection by touching the “Confirm” virtual button 607, when the user and their device 100 are in proximity of the public electronic display 501, information on myths and legends of King Alfred will be provided to them. On the other hand, if another user selects the “Military achievements” option 604 then, when they and their device 100 are in proximity to the public electronic display 501, information on the military achievements of King Alfred will be provided to them. Individual users are therefore provided with a more personalised experience of the museum exhibition.

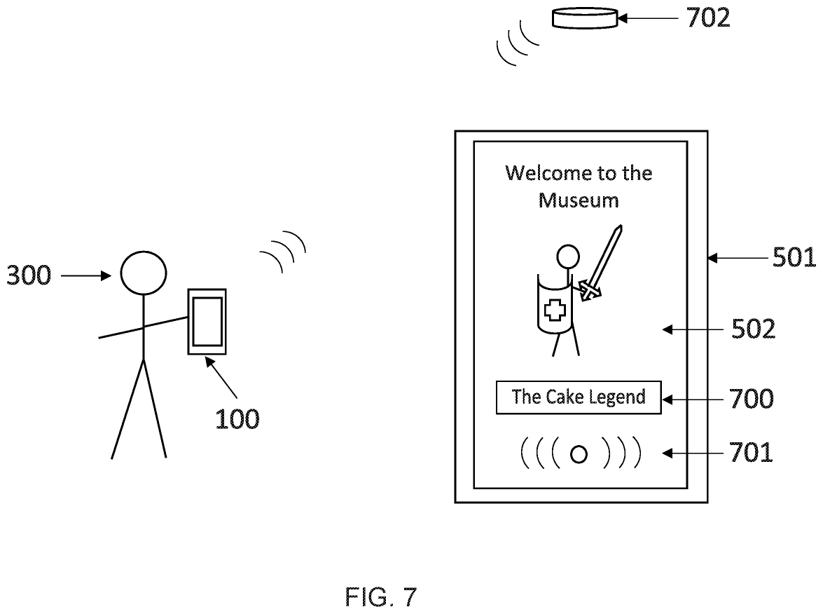

FIG. 7 shows the experience of the user of FIG. 6 who selected the “Myths and legends” option 604. In this example, the museum is equipped with a fixed beacon device 702 (e.g. a BLE beacon device) which continuously transmits beacon signals comprising a unique identifier (e.g. UUID) associated with the museum. When the device detects beacon signals comprising this unique identifier (the unique identifier being stored in the storage medium 103 of the device 100 when the museum app is downloaded, for example), it begins transmission of its own beacon signal for detection by the public electronic display 501.

The beacon signal transmitted by the device 100 indicates to the public electronic display 501 (which comprises a communication interface (not shown) for receiving the beacon signal) that the user has selected the “Myths and legends” option 604. The selection of this option is indicated in the user information of a data packet 205 comprised in the beacon signal, for example. For example, the user information may comprise a predetermined set of bits (e.g. located at the same location in every transmitted data packet) with values which change depending on the option selected. For instance, the selection or deselection of each of the options 602 to 606 may be indicated by a single respective bit (e.g. ‘1’ for selected, ‘0’ for deselected) at a predetermined location. The location of the predetermined bits may be known to the public electronic display 501 in advance and indicated to the device 100 by the museum app, for example.

In response to receiving the beacon signal indicating the selection of the “Myths and legends” option 604, the public electronic display 501 causes the information screen 502 to output information 700 about myths and legends of King Alfred in place of the default information 503 (which is displayed, for example, when no beacon signal transmitted by a device 100 is detected). In this case, the legend is “The Cake Legend” of King Alfred, as indicated by the information 700. In addition to the visual information 700 identifying “The Cake Legend”, an audio icon 701 is also presented. This indicates to the user 300 that information (e.g. the story of “The Cake Legend” itself) is being told in an audio format (e.g. via a loudspeaker (not shown) of the public electronic display 501). In an example, the “Myths and legends” information is presented on the public electronic display 501 for a predetermined time (e.g. 60 seconds) or until, based on detecting regular repetitions of the beacon signal transmitted by the device 100, the measured received beacon signal power falls below a predetermined threshold. After this, the public electronic display 501 goes back to displaying the original “Key facts” information 503.

Thus, exhibition information provided to the user in response to option(s) selected by the user using the museum app may be provided in a range of different formats. For example, short pieces of information (e.g. the “Key facts” information) may be presented in a visual format to be quickly glanced at by the user. On the other hand, longer pieces of information (e.g. the story of “The Cake Legend”) may be presented in an audio format to be listened to by the user. This alleviates the need for larger amounts of text information to be displayed, which may be difficult and cumbersome for the user to read as they walk around the museum.

This is a simplified example and the user information included in a beacon signal transmitted by the device 100 to the public electronic display 501 may include further information indicated by the user in their operation of the museum app.

For example, in addition to the user being able to select the type of exhibition information they want to be presented with by selecting one or more of the selectable options 602 to 606 (if a plurality of options is selected, the public electronic display may display each type of selected information (e.g. “Key facts” and “Myths and legends”), either concurrently or alternately), they may also be presented with the opportunity to select language and/or accessibility preferences.

For instance, the app may provide a language selection screen (not shown) presenting the user with a plurality of selectable languages. Information (whether visual or audio) is then presented in the language which the user selects. The selected language is indicated in the user information of the data packet 205 of the transmitted beacon signal, for example. This may be particularly useful for large international museums, for example, which are visited by people from many different countries around the world who speak many different languages.

In another example, the app may provide an accessibility selection screen (not shown) presenting the user with a plurality of selectable accessibility options. These may include, for example, text-to-speech (e.g. for users who are partially sighted) or speech-to-text (e.g. for users who are hard of hearing) options which are then implemented when information is presented. Again, the selected accessibility option(s) are indicated in the user information of the data packet 205 of the transmitted beacon signal, for example.

The present technique thus enables information provided to a user during an exhibition to be personalised to that user. The information can be personalised in terms of the type of information that is provided (so that it better reflects the user's interests and expertise—e.g. a history scholar may be more interested in “Historical evidence” information whereas a history layperson may be more interested in “Key facts” information), the language the information is provided in (e.g. so the user is able to enjoy the information in a language they are comfortable with) and in an accessible way to that user (e.g. so a user with a disability is provided with the information in a way which is most appropriate to them). At the same time, since the beacon signal indicating the user's personalisation requirements is only transmitted when the beacon signal transmitted by the fixed beacon device 702 and comprising the unique identifier of the museum is detected, the device 100 is not continuously transmitting this beacon signal wherever the user goes. Privacy of the user's information is therefore improved.

In the case the user information provided with the beacon signal is encrypted (e.g. in the way previously described), the encryption key for encrypting the user information may be provided to the user device 100 with the museum app when it is downloaded. The encryption key is a corresponding asymmetric encryption key to a secret decryption key known only to devices such as the public electronic display 501 operated by the museum. This allows the user information to be encrypted by the device 100 and decrypted only by devices legitimately operated by the museum.

In a variation, rather than the beacon signal directly indicating the personalisation requirements of the user, the beacon signal may indicate a unique identifier of the user. This unique identifier is then used to look up the user's personalisation requirements.

For example, to use the example of FIGS. 5 to 7, when the user downloads the museum app, they may also create a secure digital account with the museum in order to use the app. The creation of the secure account requires the creation of a unique identifier (e.g. user's email address) and password. Once the account is created, the user is then presented with the preference selection screen 600 (together with any other preference selection screes (not shown) for selected accessibility options, language options and the like). The user's selected options are then securely stored in the user's account. The user's account is securely hosted at a server (not shown) operated by or on behalf of the museum, for example.

When the user is at the museum and the device 100 detects the beacon signal transmitted by the fixed beacon device 702, the device 100 begins transmission of its own beacon signal for detection by the public electronic display 501 in the way previously described. However, in this case, rather than the selected options of the user being indicated directly in the user information of the transmitted data packet 205 (e.g. by the configuration of one or more predetermined bits), the user information instead indicates the unique identifier of the user. The public electronic display is securely connected to the server hosting the user's account and, based on the received unique identifier of the user, is able to look up the user's account and obtain information indicating the user's selected options. The public electronic display then displays the exhibition information in accordance with the user's selected options.

This variation thus enables the user's experience to be personalised without the need for any information about the user's options to be derivable from the beacon signal transmitted by the user's device. Rather, the only information derivable from the beacon signal (which may also be encrypted in the way previously described, for example) is the user's unique identifier associated with their account. However, this can only be used by an authorised party who is able to access the secure server on which the user's account details are stored to access the information about the user's options. Thus, when the receiver of the beacon signal transmitted by the user device 100 (in this example, the public electronic display 501) is securely connectable to another apparatus securely storing information about the user, this presents a further option to secure data about the user.

The present technique may also be applied to public electronic displays in other settings. For example, in a coffee shop, if the user device's beacon signal indicates (either directly or by a unique user identifier associated with a user's digital account) that the user has a certain allergy or certain likes and dislikes (as preconfigured by the user using a suitable app or web portal, for example), an electronic menu may display only products which are suitable for that user when the user device's beacon signal is detected. Furthermore, the user device 100 may only transmit such a beacon signal when triggered to do so, e.g. by detection of a Wi-Fi hotspot known to be associated with the coffee shop, by detection of a beacon signal from a fixed beacon device indicating a unique identifier associated with the coffee shop or by detection by GNSS circuitry (not shown) of the device 100 that the device is in the vicinity of the coffee shop. In these examples, information indicating the name (e.g. SSID) of the coffee shop Wi-Fi hotspot, the unique identifier associated with the coffee shop and/or the GNSS coordinates of the coffee shop is provided with the option selection app of the coffee shop when it is downloaded, for example. The option selection app of the coffee shop is similar to that of the museum app, for example, but with the selectable options being adjusted accordingly (e.g. instead of being presented with options about which historical information to display, the user is presented with options to select any allergies they have and/or any likes or dislikes they have).

In the above examples, receipt of the beacon signal from the device 100 causes another device (e.g. TV 301 or public electronic display 501) to provide user specific information to the user. Alternatively, or in addition, in response to another device receiving the beacon signal, that other device may cause information to be transmitted to the device 100 itself for display to the user.

For instance, going back to the example of FIGS. 5 to 7, instead of the public electronic display 501 providing information specific to the user in response to receiving the beacon signal from the device 100 (e.g. based on the user's selected options in the museum app), it may instead cause a signal to be transmitted back to the device 100 which causes the device to provide this information. This allows, for example, the public electronic display 501 to continue displaying the “Key facts” information 503 (which is likely to be of general interest to everyone) whilst the specific information of interest to the user (e.g. the “Myths and legends” information) is presented to the user on the device 100.

This is achieved by, for example, the user registering for a digital account with the museum (as previously described) and the device 100 providing the user's unique identifier in the beacon signal. The user's account is then looked up to determine their selected options (e.g. “Myths and legends”, in “English” and with “speech-to-text” enabled) and information fulfilling the requirements of these options is provided to the device 100. In an example, the user is signed in to their account on the museum app and therefore the information is provided to the user as part of the museum app interface using, for example, the museum's Wi-Fi network or the user's cellular network. In another example, the device establishes a communication session with a device of the museum (e.g. a Bluetooth pairing) in order to receive the information. Instructions for establishing the communication session (including, for example, a Bluetooth pairing code) are provided on the public electronic display 501, for example. The information to be presented to the user (e.g. the text and/or audio describing “The Cake Legend”) may itself be transmitted to the device 100. Alternatively, for example, a URL of a webpage comprising the information may be transmitted to the device 100.

Providing user-specific information to the device 100 may also be useful in other situations. For example, the previously discussed user-specific coffee shop menu may be provided to the user device 100 rather than causing the information on the public electronic display 501 to be changed. Similarly, subtitles may be provided to the user on their device 100 rather than on the TV 301. This allows, for example, one type of display which is accessible to multiple people (e.g. TV in a common area, public electronic display in a museum or coffee shop) to provide general information which is applicable to most users. Specific information based on a user's selected options is then delivered to the device 100 of the user (which is a type of display generally only accessible to the user who carries it).

Delivering user-specific information to the device 100 also potentially enables a wider range of use cases. For example, when a user is in a coffee shop and the device 100 is triggered (e.g. by coffee shop Wi-Fi, fixed beacon or GNSS) to transmit its beacon signal, additional information which would not be appropriate to provide to all users via the public electronic display 501 (e.g. a discount voucher based on the user's loyalty and tailored to their tastes—e.g. 10% discount on the user's most often purchased drink) can be provided to the user more easily.

In an example, the voucher may be authenticated on presentation of the voucher (e.g. on a display of the device 100) at a point-of-sale, POS, device (not shown) by continued detection of the beacon signal transmitted by the device 100 (e.g. by a beacon signal receiver of the POS device). Whilst the device 100 remains located in the location associated with the voucher (e.g. coffee shop where it can detect the coffee shop Wi-Fi SSID), it will continue transmitting the beacon signal associated with that location. The beacon signal indicates the user's unique identifier. Detection of the beacon signal at the same time as presentation of the voucher is a necessary condition for the voucher to be accepted by the POS device. The voucher may, for example, have a unique voucher identifier which is associated with the user identifier indicated by the beacon signal. This means the voucher can only be used by the user it was originally provided to. The unique voucher identifier is encoded in, for example, a barcode or quick response (QR) code which is scanned at the POS device and looked up in a database to determine a related user identifier. The voucher is then only accepted if a beacon signal indicating that user identifier is detected within a predetermined time period (e.g. 30, 60 or 120 seconds) of the time of the scanning of the voucher. This helps ensure the voucher can only be used by the user it was intended for.

In the above examples, detection of a trusted area by the device 100 (e.g. based on detection of a particular SSID, connection to a trusted WLAN, detection of a beacon signal from a fixed beacon and/or determination of being within a predetermined distance of trusted GNSS coordinates) causes the device 100 to begin transmission of the beacon signal and the beacon signal is encrypted. Multiple layers of security are therefore provided. Alternative approaches are possible depending on the sensitivity of the data included in the beacon signal.

For example, device 100 may continuously transmit the beacon signal in an encrypted format. However, when it is in a trusted area, it may then transmit the beacon signal in an unencrypted format. This helps secure the user's data when they are outside the trusted area (since only authorised parties can decrypt the user information comprised in the beacon signal) whilst also providing a high reliability of user services. For example, if the user enters a coffee shop with which they have registered and the coffee shop Wi-Fi (which the device 100, in another embodiment, uses to trigger transmission of the beacon signal) is not working, the fact the beacon signal is continuously being transmitted means it is still detected and decrypted by an appropriate apparatus of the coffee shop. The encryption, however, means it is difficult for unauthorised parties to determine the user information from the transmitted signal when the user, for example, travels to and from the coffee shop. On the other hand, when the user returns home and connects to their home Wi-Fi network, transmission of the beacon signal in an unencrypted format means any device in the user's home can receive and act in response to the beacon signal. This alleviates the need, for example, for the user to individually set up each device in their home to decrypt the beacon signal (by sharing the decryption key during a pairing process, for example), thereby improving convenience for the user.

In an example, the transmission of the same beacon signal by the device 100 may be triggered by each of a plurality of different related locations. For example, if transmission of the beacon signal is started in response to detection of a particular WLAN SSID and multiple related locations have the same WLAN SSID, transmission of the beacon signal will occur at each of those locations. This is useful, for example, for chain stores such as a chain of coffee shops with free Wi-Fi for customers in which, for each coffee shop, the Wi-Fi router has the same SSID (to allow customers to easily determine the SSID associated with the coffee shop).

In an example, to help mitigate the effects of SSID spoofing, the device 100 may transmit the beacon signal only if, for example, the user has an app associated with the chain of coffee shops open on the device 100 at the time the SSID is detected (indicating the user is likely to be wanting to use the services of the coffee shop and therefore detection of the coffee shop SSID is likely to be genuine). That is, in addition to the usual location trigger for transmitting the beacon signal (e.g. detection of a certain SSID, connection to a WLAN or detection of another beacon signal from a fixed beacon signal transmitter), a further condition of an app associated with the location (e.g. an app provided by the coffee shop whose SSID is detected, an app provided by the museum whose fixed beacon signal is detected or the like) being in an active state must also be satisfied in order for the beacon signal to be transmitted. An active state may be, for example, that the app is currently running on the device 100 (possibly along with one or more other apps), that the app is the current open app on the device 100 (e.g. the app is currently displayed on a touch screen of the device 100 to allow interaction of the user with the app) or that the app has been the current open app recently (that is, within a predetermined expiry period, e.g. within the last 30, 60 or 120 seconds). The beacon signal will also be encrypted, as discussed above.

This may apply not just to, for example, standalone chain stores but also, for instance, kiosks or displays associated with a certain service provider within a larger retail environment (e.g. shopping mall or large supermarket). For example, a coffee or baked goods kiosk in a supermarket may transmit an SSID (or, for example, a static beacon signal) associated with the brand of the coffee or baked goods, and this will be the same for all such kiosks in different supermarkets. In response, the device 100 transmits a beacon signal to facilitate the user's use of that kiosk. For example, if the kiosk includes a public electronic display (like display 501) displaying adverts of the latest products provided by the kiosk and the beacon signal indicates the user requires subtitles, this may cause the display to automatically display the advert with subtitles. It will do this until the beacon signal transmitted by the device 100 is no longer detected (or, for example, if the measured strength or quality of the received beacon signal reduces by more than a predetermined proportion of its originally measured value).

In another example, the device 100 may transmit the beacon signal in an unencrypted format but only when in a trusted area. Security outside the trusted area is therefore maintained (since no beacon signal is transmitted and thus no beacon signal comprising user information is detectable) whilst greater user convenience when in the trusted area (again, due to there being no need to share a decryption key with each device in the trusted in advance) is achieved.

The user's preferences regarding when to transmit being signals and whether or not they are encrypted can be configured, for example, in a suitable settings menu (not shown) of the device 100, for example. In an example, the user may have various types of trusted areas. For example, the user's home may be a “Tier 1” trusted area meaning, for example, transmission of unencrypted beacon signals is permitted. However, other trusted areas outside the home (e.g. museums, coffee shops and the like) may be “Tier 2” trusted areas meaning, for example, transmission of beacon signals is permitted but those beacon signals must be encrypted.

In an example, to improve user convenience whilst maintaining user security, the device 100 may always transmit beacon signals in an encrypted format. However, for devices owned by the user, the decryption key may be shared from one such device to another. Such devices may be, for example, those securely connected to the user's home WLAN (in which case, for example, the decryption key is securely shared over the WLAN) or those for which a user has signed into a secure online digital account (e.g. a PlayStation® Network account, Google® account or Facebook® account, in which case, for example, the decryption key is securely stored on a server (not shown) of the account administrator). This allows the user to undertake an initial pairing operation with one device (e.g. the TV 301) but to then enjoy the personalisation benefits associated with transmitting beacon signals from the device 100 in the way described whilst maintaining a high level of security.

It will be appreciated there are many other potential applications of the present technique, for example advertising displays, shop displays, vending machines and automated ordering point (e.g. fast food ordering points). Other applications in the home or office are also envisaged. For example, digital locks for homes and offices are becoming increasingly common. These typically require credentials such as passcode or biometric identifier (e.g. finger print or facial identification) to be entered. An encrypted beacon signal transmitted by a device 100 in response to, for example, the device 100 establishing a connection with the home or office WLAN may replace the use of such credentials or act as a second authentication factor (since when, for example, a hash type encryption is used, only an encrypted data packet received in the beacon signal of a legitimate user will be decryptable using the previously agreed secret decryption key).

In another example, when the encrypted beacon signal is detected and decrypted, the security level of the lock credentials may be reduced to provide improved user convenience. For example, if an 8-character passcode is usually required, this may be reduced to a 4-character passcode if a decryptable beacon signal is detected. There may also be more than two levels of security. For example, the device 100 may transmit a first beacon signal if two indicators of location are detected (e.g. successful home Wi-Fi connection combined with detection of a cell ID of a cell known to serve the user's home) and a second beacon signal if only a single indicator of location is detected (e.g. home Wi-Fi connection only). In response to detection of the first beacon signal, the lock may require no passcode and may complete an unlock operation in response to detection of the first beacon signal without any further input being required from the user. In response to detection of the second beacon signal, the lock may require a shortened passcode (e.g. 4 characters of an 8-character passcode, as exemplified above). In response to the detection of no beacon signal, on the other hand, the full passcode (e.g. the full 8-character passcode) is required. This helps achieve a balance between improved security when it is needed (e.g. when the location of the user is determined with a lower level of certainty) and improved user convenience when appropriate (e.g. when the location of the user is determined with a higher level of certainty).

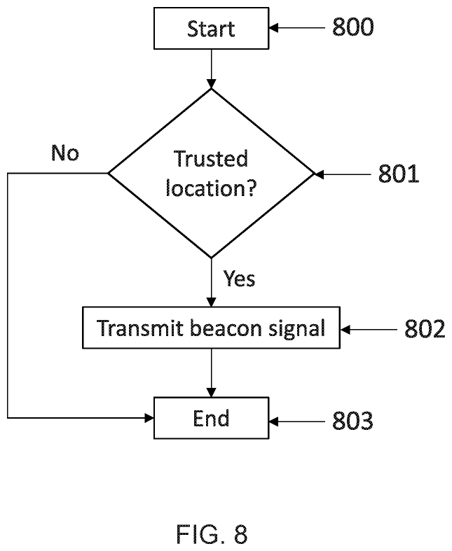

FIG. 8 shows an example method of operating a data processing apparatus according to the present technique. The device 100 is an example of such a data processing apparatus. For example, the method may be implemented by the processor 101 of the device 100.

The method starts at step 800.

At step 801, it is determined if the data processing apparatus is in a trusted location. The data processing apparatus is determined to be in a trusted location based on, for example, detection of an SSID associated with the trusted location, detection of a beacon signal associated with the trusted location, GNSS coordinates of the data processing apparatus and of the trusted location, an identifier of a cell of a cellular network serving the data processing apparatus and/or a connection of the data processing apparatus to a WLAN associated with the trusted location.

If it is determined the data processing apparatus is not in a trusted location, the method ends at step 803.

If it is determined the data processing apparatus is in a trusted location, the method proceeds to step 802 in which the data processing apparatus is caused to transmit a beacon signal. The beacon signal comprises a data packet (e.g. data packet 205) comprising information associated with a user of the data processing apparatus (e.g. a user identifier and/or information indicating one or more selected preferences or options of the user). The data packet has a predetermined property.

The method ends at step 803.

In an example, no beacon signal is transmitted if it is determined the data processing apparatus is not in a trusted location. In this case, when the data processing apparatus then moves to a trusted location, the predetermined property of the data packet is either that the data packet is encrypted (e.g. for extra security) or that the data packet is not encrypted (e.g. for improved user convenience when in the trusted location).

In another example, a beacon signal comprising an encrypted data packet is transmitted if it is determined the data processing apparatus is not in a trusted location (e.g. to maintain security). When the data processing apparatus then moves to a trusted location, the data packet is no longer encrypted (e.g. for improved user convenience when in the trusted location). Thus, in this case, the predetermined property is that the data packet is not encrypted.

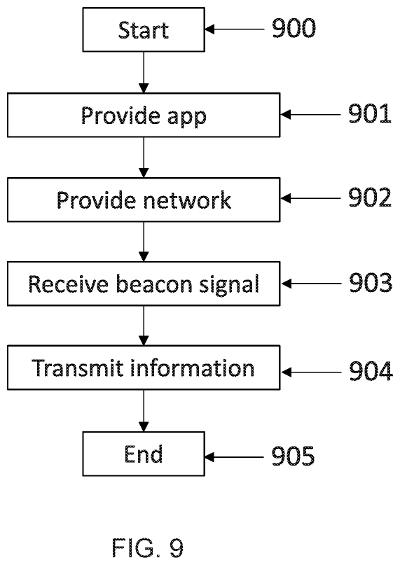

FIG. 9 shows another example method according to an embodiment. For example, the method is implemented by a goods and/or service provider of the user of the device 100 such as a coffee shop or museum.

The method starts at step 900.

At step 901, a software application (app, e.g. coffee shop app or museum app) is provided for distribution. For example, the app is made available on the Google® Play or Apple® App store.

At step 902, a wireless communications network is provided (e.g. coffee shop or museum Wi-Fi). The network is identifiable by a signal transmitted by a node of the wireless communications network (e.g. SSID transmitted by the coffee shop or museum Wi-Fi router).

At step 903, a beacon signal is received (e.g. from user device 100). The beacon signal is received by a beacon signal receiver (e.g. BLE receiver). The beacon signal is based on both authentication information associated with code components of the software application and the signal from which the wireless communications network is identifiable (e.g. the beacon signal being transmitted only in response to detection of this signal, e.g. in response to detection of the SSID of the coffee shop or museum Wi-Fi).

The authentication information may include, for example, a public key provided with the app for encrypting the beacon signal, the public key corresponding to an asymmetric secret key for decrypting the encrypted beacon signal known only to the service provider. Alternatively, or in addition, the authentication information may indicate that the source of the app (e.g. Google Play or Apple App store) has authenticated that it has genuinely issued the app on behalf of the provider of the wireless communications network. Alternatively, or in addition, the authentication information may indicate a confirmation that the providers of both the app and the wireless communications network match (e.g. according to a database indicating an association between the app provider and wireless communications network provider).

At step 904, further information is transmitted in response to the beacon signal. The further information may be transmitted, for example, to the device 100 using the same or a related communication protocol as that used to transmit the beacon signal (e.g. BLE or Bluetooth more generally) or through another communication channel (e.g. via an internet protocol (IP) session established with the device 100).

The method ends at step 905.

Embodiment(s) of the present disclosure are defined by the following numbered clauses:
1. A data processing apparatus comprising circuitry configured to:
   determine if the data processing apparatus is in a trusted location;
   if it is determined that the data processing apparatus is in a trusted location, transmit a beacon signal, the beacon signal comprising a data packet comprising information associated with a user of the data processing apparatus and the data packet having a predetermined property.
2. A data processing apparatus according to clause 1, wherein, if it is determined the data processing apparatus is not in the trusted location, the circuitry is configured to not transmit the beacon signal.
3. A data processing apparatus according to clause 2, wherein the predetermined property is that the data packet is encrypted.
4. A data processing apparatus according to clause 2, wherein the predetermined property is that the data packet is not encrypted.
5. A data processing apparatus according to clause 1, wherein:
   the predetermined property is that the data packet is not encrypted; and
   if it is determined the data processing apparatus is not in the trusted location, the circuitry is configured to encrypt the data packet and transmit the beacon signal comprising the encrypted data packet.
6. A data processing apparatus according to any preceding clause, wherein the circuitry is configured to determine the data processing apparatus is in the trusted location when a signal associated with a localised wireless network of the trusted location is detected.
7. A data processing apparatus according to clause 6, wherein the signal comprises a transmitted service set identifier, SSID, associated with the trusted location.
8. A data processing apparatus according to any preceding clause, wherein the circuitry is configured to determine that the data processing apparatus is in the trusted location when a second beacon signal associated with the trusted location is detected.
9. A data processing apparatus according to any preceding clause, wherein the circuitry is configured to determine that the data processing apparatus is in the trusted location based on a determined geocode of the data processing apparatus.
10. A data processing apparatus according to any preceding clause, wherein the circuitry is configured to determine that the data processing apparatus is in the trusted location based on an identifier of a cell of a cellular network serving the data processing apparatus.
11. A data processing apparatus according to any preceding clause, wherein the circuitry is configured to determine that the data processing apparatus is in the trusted location when the data processing apparatus is connected to a wireless local area network, WLAN, associated with the trusted location.
12. A data processing apparatus according to any preceding clause, wherein the data packet comprises information indicating a preference of the user of the data processing apparatus.
13. A data processing apparatus according to any preceding clause, wherein the data packet comprises an identifier of the user of the data processing apparatus, the identifier being associated with a digital account of the user indicating a preference of the user.
14. A data processing apparatus according to clause 11 or 12, wherein, in response to transmitting the beacon signal, the circuitry is configured to receive a response signal indicating information conforming to the preference of the user.
15. A data processing apparatus according to any preceding clause, wherein the data packet is a Bluetooth® Low Energy, BLE, advertising packet.
16. A data processing apparatus according to any preceding clause, wherein the circuitry is configured to:
   run a software application associated with the trusted location; and
   transmit the beacon signal if the data processing apparatus is in the trusted location and the software application associated with the trusted location is in an active state.
17. A method of operating a data processing apparatus, the method comprising:
   determining if the data processing apparatus is in a trusted location;
   if it is determined the data processing apparatus is in a trusted location, causing the data processing apparatus to transmit a beacon signal, the beacon signal comprising a data packet comprising information associated with a user of the data processing apparatus and the data packet having a predetermined property.
18. A program for controlling a computer to perform a method according to clause 17.
19. A storage medium storing a program according to clause 18.
20. A method comprising:
   providing a software application for distribution;
   providing a wireless communications network identifiable by a signal transmitted by a node of the wireless communications network;
   receiving a beacon signal based on both authentication information associated with code components of the software application and the signal from which the wireless communications network is identifiable; and
   transmitting further information in response to the beacon signal.
21. A non-transitory storage medium comprising code components which cause a computer to perform a method according to clause 17.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a machine-readable medium (in particular, a non-transitory machine-readable medium) carrying such software, such as an optical disk, a magnetic disk, semiconductor memory or the like, is also considered to represent an embodiment of the present disclosure. In particular, the present disclosure should be understood to include a non-transitory storage medium comprising code components which cause a computer to perform any of the disclosed method(s).

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

1. A data processing apparatus comprising circuitry configured to:
determine if the data processing apparatus is in a trusted location;
if it is determined that the data processing apparatus is in a trusted location, transmit a beacon signal, the beacon signal comprising a data packet comprising information associated with a user of the data processing apparatus and the data packet having a predetermined property.

2. The data processing apparatus according to claim 1, wherein, if it is determined the data processing apparatus is not in the trusted location, the circuitry is configured to not transmit the beacon signal.

3. The data processing apparatus according to claim 2, wherein the predetermined property is that the data packet is encrypted.

4. The data processing apparatus according to claim 2, wherein the predetermined property is that the data packet is not encrypted.

5. The data processing apparatus according to claim 1, wherein:
the predetermined property is that the data packet is not encrypted; and
if it is determined the data processing apparatus is not in the trusted location, the circuitry is configured to encrypt the data packet and transmit the beacon signal comprising the encrypted data packet.

6. The data processing apparatus according to claim 1, wherein the circuitry is configured to determine the data processing apparatus is in the trusted location when a signal associated with a localized wireless network of the trusted location is detected.

7. The data processing apparatus according to claim 6, wherein the signal comprises a transmitted service set identifier (SSID), associated with the trusted location.

8. The data processing apparatus according to claim 1, wherein the circuitry is configured to determine that the data processing apparatus is in the trusted location when a second beacon signal associated with the trusted location is detected.

9. The data processing apparatus according to claim 1, wherein the circuitry is configured to determine that the data processing apparatus is in the trusted location based on a determined geocode of the data processing apparatus.

10. The data processing apparatus according to claim 1, wherein the circuitry is configured to determine that the data processing apparatus is in the trusted location based on an identifier of a cell of a cellular network serving the data processing apparatus.

11. The data processing apparatus according to claim 1, wherein the circuitry is configured to determine that the data processing apparatus is in the trusted location when the data processing apparatus is connected to a wireless local area network (WLAN), associated with the trusted location.

12. The data processing apparatus according to claim 1, wherein the data packet comprises information indicating a preference of the user of the data processing apparatus.

13. The data processing apparatus according to claim 1, wherein the data packet comprises an identifier of the user of the data processing apparatus, the identifier being associated with a digital account of the user indicating a preference of the user.

14. The data processing apparatus according to claim 11, wherein, in response to transmitting the beacon signal, the circuitry is configured to receive a response signal indicating information conforming to the preference of the user.

15. The data processing apparatus according to claim 1, wherein the data packet is a Bluetooth® Low Energy (BLE) advertising packet.

16. The data processing apparatus according to claim 1, wherein the circuitry is configured to:
run a software application associated with the trusted location; and
transmit the beacon signal if the data processing apparatus is in the trusted location and the software application associated with the trusted location is in an active state.

17. A method of operating a data processing apparatus, the method comprising:
determining if the data processing apparatus is in a trusted location;
if it is determined the data processing apparatus is in a trusted location, causing the data processing apparatus to transmit a beacon signal, the beacon signal comprising a data packet comprising information associated with a user of the data processing apparatus and the data packet having a predetermined property.

18. A non-transitory computer readable medium storing a computer program for controlling a computer to perform the method according to claim 17.

19. (canceled)

20. A method comprising:
providing a software application for distribution;
providing a wireless communications network identifiable by a signal transmitted by a node of the wireless communications network;
receiving a beacon signal based on both authentication information associated with code components of the software application and the signal from which the wireless communications network is identifiable; and
transmitting further information in response to the beacon signal.
